(19) United States
(12) Patent Application Publication
(10) Pub. No.: US 2023/0408454 A1
(43) Pub. Date: Dec. 21, 2023

(54) Ascertaining the Concentration of Potentially Infectious Aerosol Particles in a Volume

(71) Applicant: Siemens Aktiengesellschaft, ünchen (DE)

(72) Inventors: Oliver Stier, Berlin (DE); Oliver Theile, Berlin (DE)

(73) Assignee: Siemens Aktiengesellschaft, München (DE)

(21) Appl. No.: 18/251,767

(22) PCT Filed: Oct. 11, 2021
(86) PCT No.: PCT/EP2021/077988

§ 371 Date: Oct. 11, 2021

(30) Foreign Application Priority Data
Nov. 6, 2020 (EP) 20206230.3

(51) Int. Cl. G01N 29/14

(52) U.S. Cl. CPC G01N 29/14; G01N 2291/02809; G01N 2291/0215; G01N 2291/02408

(57) ABSTRACT

The teachings herein include methods for ascertaining a concentration (c_{A}) of potentially infectious aerosol particles in a volume (V), for example in a conference room, methods for ascertaining an inhalation dose (Z), a device (200), a controller, and a display device. To improve the determination of a concentration (c_{A}) of potentially infectious aerosol particles in a volume (V) with emitters (E1, . . . , En), the method may include: recording at least one time course of an acoustic variable (AS) in the volume (V), said variable being associated with one or more of the emitters (E1, . . . , En), ascertaining an emission (Q) of aerosol particles for at least one of the emitters (E1, . . . , En) on the basis of the recorded time course of the acoustic variable (AS) and ascertaining the concentration (c_{A}) on the basis of the at least one emission (Q).

### CROSS-REFERENCE TO RELATED APPLICATIONS

This application is a U.S. National Stage Application of International Application No. PCT/EP2021/077988 filed Oct. 11, 2021, which designates the United States of America, and claims priority to EP Application No. 20206230.3 filed Nov. 6, 2020, the contents of which are hereby incorporated by reference in their entirety.

### TECHNICAL FIELD

The present disclosure relates to ascertaining a concentration of potentially infectious aerosol particles in a volume, e.g. in a conference room. Various embodiments of the teachings herein may include systems and/or methods for ascertaining an inhalation dose, a device for ascertaining a concentration, a controller, and a display device.

### BACKGROUND

An aerosol is a heterogeneous mixture (a dispersion) consisting of solid or liquid suspended particles in the (respiratory) air. Of particular interest is the proportion of potentially infectious aerosol particles in the air in the volume. An aerosol is considered infectious if it is emitted by a person/an emitter who is infected with a disease known to spread via aerosols.

### SUMMARY

The teachings of the present disclosure may allow determination of a concentration of potentially infectious aerosol particles. For example, some embodiments of the teachings herein include a method for ascertaining a concentration of a potentially infectious aerosol in a volume, wherein the volume comprises one or more emitters of the aerosol, comprising: recording at least one time course of an acoustic variable in the volume, the acoustic variable being associated with one or more of the emitters, ascertaining an emission of the aerosol for at least one of the emitters based on the recorded time course of the acoustic variable, and ascertaining the concentration on the basis of the at least one emission.

In some embodiments, one of the acoustic variables (AP) comprises a sound pressure level and/or an audio signal in the volume (V).

In some embodiments, at least a part of one or more of the time courses of the acoustic variable (AS) is assigned to one of the emitters (E1, . . . , En) and/or a group of emitters.

In some embodiments, the emission (Q) is ascertained by integrating an emission rate (q), the emission rate (q) being ascertained as a function of the at least one time course of the acoustic variable (AS).

In some embodiments, an emission (Q) is ascertained for each of a plurality of emitters (E1, . . . , En) and wherein the concentration (c_{A}) is ascertained on the basis of the largest of the determined emissions (Q).

In some embodiments, a proportion factor for weighting the emissions (Q) is taken into account to ascertain the concentration (c_{A}).

In some embodiments, a decrease rate (λ) of potentially infectious aerosol particles, in particular due to window ventilation, an air-conditioning system, air purification and/or a death rate of viruses, is taken into account to ascertain the concentration (c_{A}) and/or the emission (Q).

In some embodiments, a gas, in particular CO2 and/or H2, occurring in the respiratory air is detected to ascertain a decrease rate (λ) of potentially infectious aerosol particles in the respiratory air.

In some embodiments, the method includes a weighting of the emission (Q) on the basis of a detection of acoustic events (AE), in particular coughing, sneezing, speaking, shouting and/or singing, in the time course of the acoustic variable (AS).

In some embodiments, segments of time courses of acoustic variables (AS) and/or segments of emissions (Q) resulting therefrom, which cannot be assigned to any emitter (E, . . . , En), are taken into account in ascertaining the concentration (c_{A}) and/or the emission (Q).

As another example, some embodiments include a method for ascertaining an inhalation dose (Z), comprising ascertaining a concentration (c_{A}) by means of one or more methods as described herein, and ascertaining an expected inhalation dose (Z) for at least one person in the volume (V) at a time (t).

In some embodiments, the inhalation dose (Z) is ascertained from an integral of the concentration (c_{A}) and a respiratory air demand (A) at the time (t).

As another example, some embodiments include a device (200) for ascertaining a concentration (c_{A}) of potentially infectious aerosol particles in a volume (V) by means of one or more of the methods described herein, comprising: a detection device, in particular a microphone array, which is designed for recording time courses of one or more acoustic variables (AS) in the volume (V), and an evaluation device designed for ascertaining an emission (Q) of aerosol particles for at least one of the emitters (E1, . . . , En) on the basis of the recorded time course of the acoustic variable (AS), wherein the device (200) is designed for ascertaining the concentration (c_{A}) on the basis of the at least one emission (Q).

In some embodiments, the device (200) includes at least one interface which is designed for connecting detection devices external to the device (200), in particular smartphones and/or microphones.

As another example, some embodiments include a controller, designed for controlling a room ventilation and/or air purification system on the basis of a concentration (c_{A}) according to one or more of the methods described herein and/or on the basis of an inhalation dose (Z) as described herein.

As another example, some of the embodiments include a display device for a room, which is designed for ascertaining and/or displaying a recommended ventilation level on the basis of a concentration (c_{A}) or an inhalation dose (Z) determined according to any of the methods described herein.

### BRIEF DESCRIPTION OF THE DRAWINGS

The teachings of the present disclosure are described and explained in more detail below on the basis of the exemplary embodiments illustrated in the figures. In the drawings:

FIG. 1 shows a schematic representation of a room with a device for ascertaining a concentration of potentially infectious aerosol particles incorporating teachings of the present disclosure;

FIG. 2 shows a schematic representation of a device for ascertaining a concentration of potentially infectious aerosol particles incorporating teachings of the present disclosure;

FIG. 3 shows a schematic representation of a further room with an alternative device incorporating teachings of the present disclosure;

FIG. 4 shows a schematic representation of a device which is designed for evaluating a plurality of time courses incorporating teachings of the present disclosure; and

FIG. 5 shows a schematic representation of a device for ascertaining an inhalation dose incorporating teachings of the present disclosure.

### DETAILED DESCRIPTION

The concentration of potentially infectious aerosol particles in the volume correlates with the number of aerosol particles per unit volume.

The emitters are the persons present in the room, i.e. in the volume, who emit aerosol particles through their breathing, speaking, singing, etc. The loudness at which a person (an emitter) speaks, shouts or screams, sings, coughs and/or sneezes correlates with the emission of aerosols. The emission and thus the aerosol concentration in a room can be ascertained on the basis of a time course of one or more acoustic variables, with such a high accuracy that an infection risk can be estimated very precisely. This allows the concentration of potentially infectious aerosols in rooms to be determined. The measures that can then be taken (ventilation/exiting the room) significantly reduce the likelihood of infection.

The emission can be the number of solid and/or liquid suspended particles (aerosol particles) emitted by or attributed to an emitter. It is feasible to ascertain absolute numbers of particles, but other correlated emission values or dimensionless auxiliary variables correlated with the emission can also be used.

The time course of the acoustic variable can be an audio signal from the volume V. It is conceivable that an audio signal is available for each of the emitters (e.g. with one microphone per emitter). For example, in the audio signal, it can be assumed that the amplitude directly correlates with an emission of aerosols at this time. Microphone arrays and frequency analysis can also be used to logically assign components of an audio signal to the emitters.

The volume in this case is the reference variable of the space in which the concentration is to be ascertained. The volume corresponds, for example, to the capacity of a room. In addition to a room in a building, this room can also be a vehicle interior, a train compartment, rooms in (cruise) ships, or an aircraft cabin.

In some embodiments, one of the acoustic variables comprises a sound pressure level and/or an audio signal in the volume. Based on an empirical correlation between sound volume and emission of aerosol particles, the emission rate of aerosol particles per unit time can be ascertained from the time course of the sound pressure level and/or the audio signal, and the emission of potentially infectious aerosols can be inferred from this.

In some embodiments, at least a part (a single time segment) of one or more of the time courses of the acoustic variable is assigned to one of the emitters and/or to a group of emitters. By applying signal processing methods to the acoustic variables and corresponding analyses, it is possible to locate individual emitters within the volume and to allocate the signal segments to the emitters. In the simplest case, this is carried out by means of a dedicated microphone per emitter. If a single device with integrated microphones is to be provided, it has proved advantageous to provide a microphone array and, using the acoustic variables recorded with the array, to assign emitters to their recorded acoustic variables (e.g. speech). Here, not only can phase shift evaluations, triangulation and transit-time calculations be carried out to locate emitters in the volume, but also FFT (Fast Fourier Transform) analyses of the voices of the speakers and/or singers as well as other analysis methods can be applied to perform location-independent detection of the speakers. As a result, components of acoustic variables emitted in the volume are allocated to individual emitters. An individual emission profile can thus be created for each emitter.

In other words, at least parts of the time course of the acoustic variable are allocated to one or more of the emitters. This has the advantage that it allows calculations to be performed on an individual emitter basis. However, allocation is also possible on the basis of an emission rate and an absolute emission. The parts can be assigned on the basis of voice analyses or other acoustic parameters.

If an emission is calculated from a total volume of all emitters, this provides only an approximate indicator of the emission of potentially infectious aerosol particles and does not indicate the emitter that poses the greatest risk. Here, one could conservatively assign the entire aerosol emission to a notional emitter.

In some embodiments, the emission is ascertained by integrating an emission rate. The emission rate is ascertained as a function of the at least one time course of the acoustic variable. In other words, the differential equation that describes the rate of change over time of the emission can be solved. The emission rate can represent a time course for one or more emitters. This can be performed for each of the emitters. The volume V can thus be used to ascertain the concentration of the aerosol at the time t in the room. If the concentration exceeds a limit value, a ventilation recommendation can be issued, a ventilation system can be activated or further measures can be taken.

In some embodiments, an emission is determined for each of a plurality of emitters each and the concentration is ascertained on the basis of the largest of the determined emissions. In some embodiments, on the basis of the time courses of concentrations the one that provides the greatest contribution can be chosen for each emitter. This allows the emitter to be chosen from which the greatest risk is posed, so the risk is not underestimated. If the group is so large or if the incidence is so high, it can be assumed that there are multiple people infected. Accordingly, the n emitters with the n highest emissions can be used as a basis for ascertaining an exact risk value. Since the method can be calculated in real time with only a small delay, the emitters that currently provide the largest contribution to the concentration can provide the basis for calculating the concentration of potentially infectious aerosol particles at any time.

In some embodiments, the emission rate which contributes the largest proportion to the potentially infectious concentration is taken into account for determining the potentially infectious concentration. Therefore, if multiple emission rates are determined for multiple emitters or groups of emitters, one of the emission rates is selected. Choosing the emission rate which poses the greatest risk, which thus provides the largest contribution to the concentration, provides a good option for achieving high accuracy in the risk estimation with a low tendency to overestimate the risk.

If the entire acoustic situation becomes indistinguishable because too many emitters are acoustically active at the same time, i.e. simultaneously speaking, singing, coughing and/or sneezing, the method can be designed in such a way that the identified emissions are attributed to a notional emitter, the emissions of which are then added in turn to at least groups of emitters or, in the extreme case, to all emitters.

In some embodiments, it is assumed that a definable proportion factor of the emissions or concentration is considered infectious. For example, in the case of very high incidences, everything emitted into the room can be considered potentially infectious. The proportion factor would then be one. At lower incidences it could be assumed that at least one person in the room is infectious and an evaluation of the current aerosol concentration or the quantity of pollutants takes place accordingly. The opposite assumption, that no emitter is infectious, leads straightforwardly to pollutant quantities, concentrations, inhalations and risks of infection of zero and is not compatible with the intended purpose of the method and the associated device. However, it can probably be assumed for short periods that no emitter is infectious, and simply no emissions are generated during this time. This may be the case during breaks.

In some embodiments, a decrease rate of potentially infectious aerosol particles is taken into account for ascertaining the concentration and/or emission. In particular, window ventilation, an air conditioning system, air purification system and/or a death rate of viruses are relevant parameters here. For each of these parameters, an air exchange rate or air exchange number can be defined. Taking a decrease rate into account significantly increases the accuracy of the system. The decrease rate can be taken into account with respect to an emission rate prior to the integration. This is not shown in detail in the drawings. The concentration can be ascertained particularly accurately if an air exchange balance can be defined or estimated for the volume, which is usually possible depending on the boundary conditions. It would even be possible that outdoors, e.g. in a busy place, certain assumptions regarding the air exchange rate (e.g. very low wind strength) can be made. On the basis of the method, an influx of people to this place could then be controlled.

In some embodiments, a gas, in particular CO2 and/or H2, present in the respiratory air of the people in the space can be detected to ascertain a rate of decrease of potentially infectious aerosol particles. Corresponding sensors can considerably better quantify the outflow of air from the room and take a corresponding dilution effect into account in the concentration calculation.

In some embodiments, the method include weighting the emission on the basis of acoustic event detection. Potential acoustic events include coughing, sneezing, speaking, shouting and/or singing and can be detected in the time course of the acoustic variable. By classifying acoustic events in the time courses of the acoustic variables, a dependency on a sound volume measurement can be significantly reduced and the accuracy of the calculation can be significantly improved. For example, if speech is detected and this speech can be assigned to an emitter, a very accurate emission can be ascertained for this emitter. If exceptional events are detected, such as sneezing or coughing, the sneezing and/or coughing may be given an emission excess accordingly and assigned to the corresponding emitter. In this case, an assignment can be achieved by locating the emitter by means of a microphone array, because sneezing and coughing sounds cannot be easily assigned individually based on voice profiles. It is also conceivable that exceptional events will be allocated to all emitters as an excess emission if the originator of the classified noise is not identifiable.

In some embodiments, the emissions are ascertained on an individual emitter basis. If emissions are identified that cannot be clearly allocated, these can be distributed among the emitters. Here, for example, the currently strongest emitter can be assigned an excess or be distributed as an average over all emitters.

If speech or singing are detected, the method may include an attempt to assign the emission corresponding to the loudness to an existing emitter. If this is not successful, a new emitter is created and this emission is assigned to the new emitter. If the allocation is not successful for other reasons, for example the loudness indicates that it does not originate from a single person, the following procedure can be used. Voice analysis works best provided the speakers speak in turns. If several people are speaking at the same time, their spatial differentiation (triangulation or separate microphone) can still be used to allocate their proportions of speaking time and thus their emissions, as long as it is not a so-called cocktail party situation. The cocktail party is typically used to describe situations in which hearing impaired people can no longer follow conversations because they are not able to perform a spatial separation of simultaneous conversations.

The loss of speaker differentiation, which hearing aid acousticians call the cocktail party effect, can also occur in the present method, for example when students in a classroom change places while simultaneously speaking, laughing or shouting.

In some embodiments, segments of time curves of acoustic variables and/or their resulting emissions that cannot be assigned to an emitter are assigned a weighting factor in the concentration calculation or the emission calculation.

In such exceptional cases, the system may store the associated emission or emission rate in a separate, depersonalized emission history. This means that these emissions are not attributed to a specific emitter, but to an abstract emitter.

If the loudness indicates that a known (or estimatable) number of emitters were involved in creating the sound, then it is assumed that at most one of the emitters is infectious and the emission rate and/or the emission is therefore divided by the number of emitters. If the incidence is particularly high, it can also be assumed, as already described, that several of the emitters are considered infected and hence the emission is multiplied by the number of infected and divided by the number of those involved in the noise. This normalization is necessary so that the amount of infectious aerosols is not overestimated. For example, a scream might be attributed to three children as emitters based on the loudness, but it is known that only one infected person is present in the school class. Thus at most one third of the aerosol particles exhaled during the shouting can be contagious, hence the multiplication by ⅓. If there are more infected persons than those involved in creating the noise, the system assumes that all emitters involved in the noise are infected and all emissions are counted without a discount.

In some embodiments, segments of time curves of acoustic variables and/or their resulting emissions that cannot be assigned to an emitter are taken into account in ascertaining the concentration. This can be done, for example, by applying a factor or using the notional emitter described. This ensures that all emissions generated in the volume are also included in the calculation of the concentration.

Some embodiments include a method for ascertaining an inhalation dose for at least one person in the volume at a time. For this purpose, a concentration, in particular a time curve of the concentration, is ascertained by one or more of the methods described herein and the inhalation dose of the person is ascertained on the basis of the concentration. Thus, a risk for a real person (an emitter) and/or a notional person can be directly quantified and measures can be derived. Since the inhalation dose is a time-dependent variable, analysis of the inhalation dose significantly improves the accuracy of a risk determination, since a high concentration at the beginning of a meeting (e.g. initial singing) is significantly more important than singing at the end.

In some embodiments, the inhalation dose is ascertained on the basis of an integral over the product of concentration of potentially infectious aerosol particles (pollutant concentration) and a respiratory air demand at the time. The respiratory air demand can be averaged and chosen as a constant or as a dynamic variable depending on various parameters. The respiratory air demand depends on physical activity, so it will have a different value for the users of a conference room than for users of a sports hall.

It is technically possible to measure or estimate the respiratory air demand individually and in a time-dependent manner, e.g. by means of a fitness bracelet, but this is not a prerequisite for the application of the methods described herein. The initial value of the respiratory air demand may be set in an individually configurable app client on the user's smartphone. In some embodiments, an interface to a fitness bracelet or similar device is provided, so that a real-time value for the respiratory air demand can be automatically adopted, if available. For a smartphone-independent display in the room itself, a fixed value is set for the respiratory air demand, which only takes into account whether the room is a sports hall or a classroom, etc. In this calculation, the device assumes an identical inhalation dose for all persons present, thus, a typical level of physical activity for the intended use of the room for all the people in it.

Some embodiments include a device for ascertaining a concentration of potentially infectious aerosol particles in a volume by means of one or more of the described methods. The device comprises a detection device, in particular a microphone array, which is designed for recording time curves of one or more acoustic variables in the volume. Furthermore, the device comprises an evaluation device designed for ascertaining an emission of aerosol particles for at least one of the emitters on the basis of the recorded time course of the acoustic variable. In addition, the device is designed for ascertaining the concentration on the basis of the at least one emission.

A simple embodiment can be formed by a smartphone with the integrated microphones. A dedicated device with integrated signal storage and processing is also conceivable. A cloud connection is not necessary, since the necessary computation processes do not place abnormally high demands on the computing power and can even be implemented by energy-efficient processors (e.g. on ARM architecture). Furthermore, AI-based algorithms are conceivable, which are used for voice signature recognition, among other things. Here it is conceivable to use processors optimized for the calculation of neural networks.

In some embodiments, the device has at least one interface, which is designed for connecting detection devices external to the device, in particular smartphones and/or microphones. If the detection devices are moved closer to individual emitters and there is a larger number of detection devices for the emitters, the detection accuracy increases. In some embodiments, an app client is installed on a smartphone, which carries out the recording of the necessary time courses of the acoustic variables on the smartphone of the emitter, while the calculation of the concentration is ultimately carried out centrally in the device. In some embodiments, the emission will be calculated directly on the emitter's smartphone and that only the balancing of the emissions is carried out centrally. By means of communication between the device and the terminal devices, e.g. via standard communication means such as WLAN or Bluetooth, corresponding parameters and their values, such as air exchange rates, can be easily exchanged.

Some embodiments include a controller for a room ventilation system, which is designed for controlling the room ventilation on the basis of a concentration which has been ascertained according to one or more of the methods described herein. In some embodiments, the controller can also be designed for controlling the room ventilation on the basis of an inhalation dose according to the described methods.

Some embodiments include a display device for a room, which is designed for ascertaining and displaying a ventilation recommendation on the basis of a concentration according to one or more of the methods described herein or an inhalation dose.

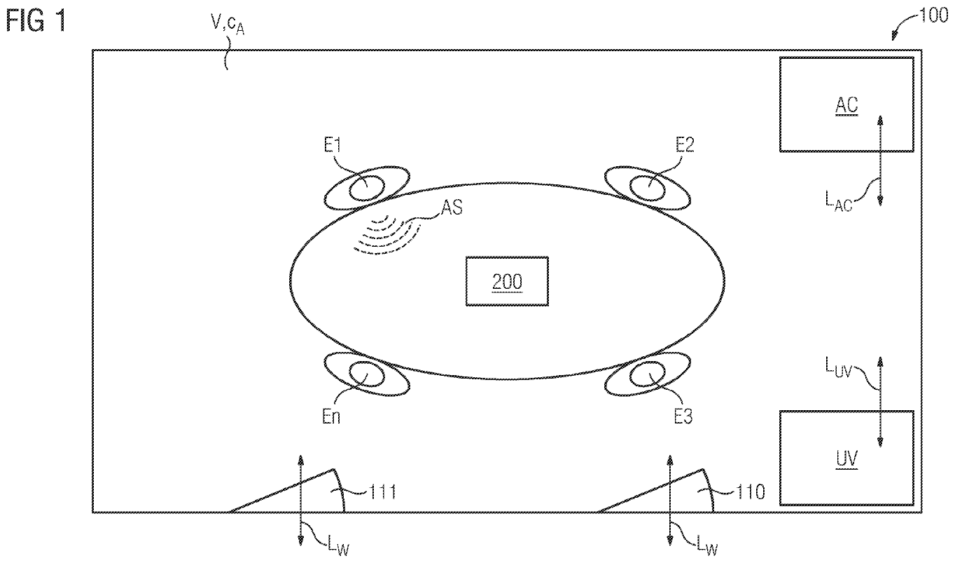

FIG. 1 shows a schematic representation of a room 100 with a device 200 for ascertaining a concentration c_{A} of potentially infectious aerosol particles incorporating teachings of the present disclosure. The concentration refers to a volume V of the room 100. In the volume V, i.e. in the room 100, there are 4 people. These people are regarded as emitters E1, . . . , En of the aerosol. The emitter E1 is speaking, which is labeled as acoustic variable AS. The device 200 is designed to ascertain a concentration c_{A} of potentially infectious aerosol particles in the room 100 or in the volume V from this acoustic variable AS, or its time course.

In addition, there are windows 110, 111 in the room 100. These windows, when open, cause an air exchange rate L_{W} through the open windows 110, 111. An air conditioning system AC causes an air exchange rate L_{AC}. An air purifier, e.g. with air purification by UV light or a corresponding filter, causes an air purification rate L_{UV}.

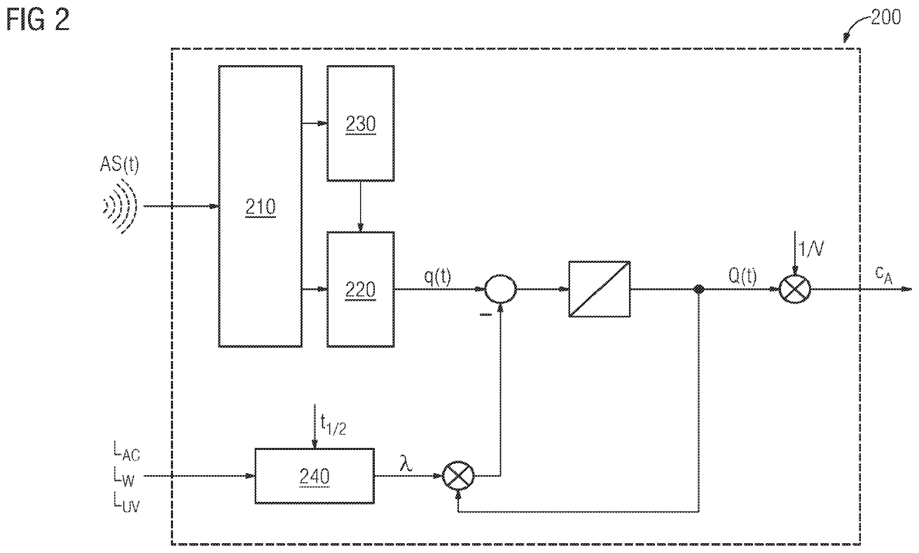

FIG. 2 shows a schematic representation of a device 200 for ascertaining a concentration c_{A} of potentially infectious aerosol particles, as is used in FIG. 1, with the reference signs known from FIG. 1 being retained. A time course of the acoustic variable AS(t) is recorded by a detection device 210, e.g. by a microphone. The time course of the acoustic variable AS(t) is in turn provided to an evaluation device 220 for acoustic variables. The evaluation device 220 can be used, for example, to examine an acoustic signal—an audio recording—for various parameters. Thus, the evaluation device 220 can be designed for calculating an emission rate q(t), wherein the emission rate q(t), for example, can be assumed to be proportional to the amplitude of an audio signal or to the sound pressure level curve in the volume or of individual emitters. The evaluation device 220 can calculate a separate emission rate q(t) for each emitter E1, . . . , En, which can be carried out on the basis of voice profile analyzes, for example. To further improve the device, a classification device 230 is present, which is designed for detecting and classifying acoustic events AE in the acoustic variables AS. For example, coughing and/or sneezing, shouting can be detected and used to weight acoustic variables or the resulting emission rate q.

The device 200 can determine the number of persons (emitters) present in the room, which can be done once, for example, by the meeting leader. A value for the number of people suspected to be infected can also be set. Up to the size of a school class (30 emitters), the number of emitters is insignificant, because until then, a fixed number of one infected person is assumed. For larger groups, however, the number of infected persons must be determined at least approximately. This can be done on the basis of the current infection numbers. Since the number of people present is only used to provide a rough estimate of an upper confidence limit for the number of infected persons, the requirements on the accuracy of the identification of the people present are low.

In some embodiments, the evaluation device 220 carries out a voice analysis and a spatial localization of the emitters (speakers/noise sources) and, based on this, assigns the components of the acoustic variable to individual emitters. For this purpose, a majority or even all of the emitters may be assigned a voice profile and a location in the room. The location helps to distinguish between similar voices, or if the voice becomes unrecognizable, e.g. due to shouting, while the voice profile often allows an emitter to be tracked when changing positions in the room.

Technically, voice analysis and localization are implemented, for example, by calculating the voice formants F1, F2, F3 and F4. These can be extracted from the raw signal using Fast Fourier Transformation (FFT) and are characteristic for each human being. The localization can be implemented by a microphone array. If the microphones are controlled using a common time base, the phase information in the FFT can be used to detect the direction. It is also possible to allocate the detection of the emitters to an artificial neural network using the features Formant and Phase. After the meeting in the room begins, the system will identify more and more emitters in the order in which they speak, and will preferably create an individual emission Q and/or emission history (a time course of the emission Q) for each of them.

In order to simplify this case, we will continue to refer to individual quantities—but all steps can also be carried out for all emitters or a selected group.

On the basis of the evaluation of the time courses of the acoustic variables AS and, if applicable, after weighting by the acoustic events AE, an emission rate q(t) can now be determined for the selected emitter. A continuous integration of the emission rate q(t) provides the current value of the emission Q or its time course Q(t) for the selected emitter. To significantly improve the accuracy of the determination of the concentration, or emission Q, in the present exemplary embodiment before the integration of the emission rate q(t), a decrease rate λ of aerosol particles based on air exchange rates or air purification rates L_{AC}, L_{W}, L_{UV} is also taken into account. A device 240 for determining an aerosol particle decrease rate λ in the volume V performs this task. The necessary parameters could be entered manually once into an application for configuring the device 240 or read out from the relevant ventilation controls. Measurement of a CO2 concentration is also conceivable in order to infer the air exchange rate L.

The half-life t_{1/2} of the infectious effect of the infectious particles under examination can be taken into account in the decrease rate λ by equating it to a corresponding depletion of particles. The decrease rate λ is multiplied by the current absolute emission (Q) and offset against the emission rate q(t).

As differential equations, the concentration c_{A}, or its rate of change, can be represented as follows:

$$\frac{d}{dt} {c}_{a} ( t ) = \frac{q ( t )}{V} - [ {L}_{W} ( t ) + {L}_{AC} ( t ) + {L}_{UV} ( t ) + \frac{ln 2}{{t}_{1 / 2}} ] * {c}_{a} ( t )$$

Since the concentration c_{A} is the relevant emission Q divided by the volume V, on the basis of the emission Q the equation can be represented as follows:

$$\frac{d}{dt} Q ( t ) = q ( t ) - [ {L}_{W} ( t ) + {L}_{AC} ( t ) + {L}_{UV} ( t ) + \frac{ln 2}{{t}_{1 / 2}} ] * Q ( t )$$

Thus, the emission Q corresponds to the actual emission in the room, taking into account reduction effects. The decrease rate λ is then the sum of the individual components L and the decrease due to the half-life:

$$λ = {L}_{W} ( t ) + {L}_{AC} ( t ) + {L}_{UV} ( t ) + \frac{ln 2}{{t}_{1 / 2}}$$

The block diagram shown in FIG. 2 can be incorporated in the calculation very easily in real time and is therefore particularly suitable for implementation in the device 200. This means that the values can be calculated directly in real time with a short delay for the evaluation device 220 and/or the classification device 230. The emission Q is multiplied by the reciprocal of the volume to obtain the concentration c_{A}.

In order to ascertain an exact concentration c_{A} that does not greatly overestimate the risk, only the emission Q of the emitter E1, . . . , En that is responsible for the most emissions Q is used to ascertain the concentration c_{A}. The emitter E1, . . . , En responsible for the most emissions can change over time. For example, a presenter might produce the most emissions Q, while a moderator will be initially responsible for the most emissions Q in the period before the presenter delivers their talk. Switching between the emissions Q can take place seamlessly, since the system can calculate a specific emission for each (acoustically active) emitter. For emitters E1, . . . , En, who are merely sitting and breathing in the room 100, a baseline value can be included in the emission Q.

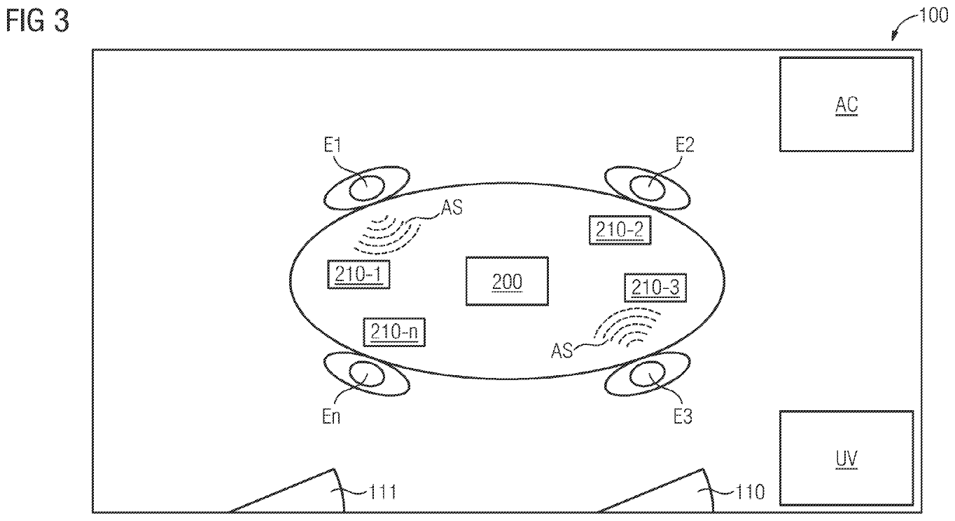

FIG. 3 shows the room 100 of FIG. 1, wherein the device 200 has been extended to include a detection device 210-1, . . . , 210-n, comprising at least one microphone each, for each of the emitters E1, . . . , En. The detection devices 210-1, . . . , 210-n can be connected to the device wirelessly or by cable. In some embodiments, the acoustic variables may already be (pre-)evaluated in the detection devices 210-1, . . . , 210-n. This can be the case, for example, if each of the emitters E1, . . . , En uses their own smartphone as a detection device 210. The detection of the number of emitters E1, . . . , En can also be implemented just as easily. In some embodiments, two emitters might share a detection device 210 and also configure this as such in the detection device 210.

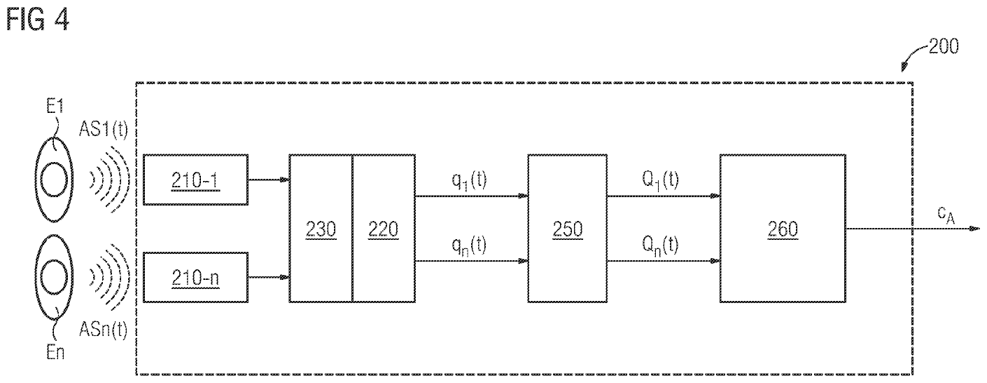

FIG. 4 shows a schematic representation of a device 200, which is designed to evaluate multiple time courses of acoustic variables AS1, . . . , ASN of multiple emitters E1, . . . , En. In the present case, it should be assumed that the detection devices 210-1 and 210-n each provide an acoustic variable, for example a time course of the sound pressure level and/or an audio signal, for each of the emitters E1 and En. The assignment of the acoustic variables AS1, . . . , ASn to the emitters with fewer detection devices 210 than emitters is equally possible, as has already been described above. In the present device 200, a classification device 230 is present, which detects and weights acoustic events AE. The evaluation device 220 determines an emission rate q₁, . . . , qₙ for each emitter E1, . . . , En. A device 250 for determining the emission Q determines the emission Q1, Qn at time t for each of the emitters E1, . . . , En. The device 250 takes into account the decrease rate A, as shown in FIG. 2. Thus, finally, the device 260 for determining the potentially infectious concentration c_{A} can ascertain the concentration c_{A}, for example, by selecting the emitter E1, . . . , En that is responsible for the largest emission Q. A parallel calculation of all variables for all emitters E1, . . . , En is possible.

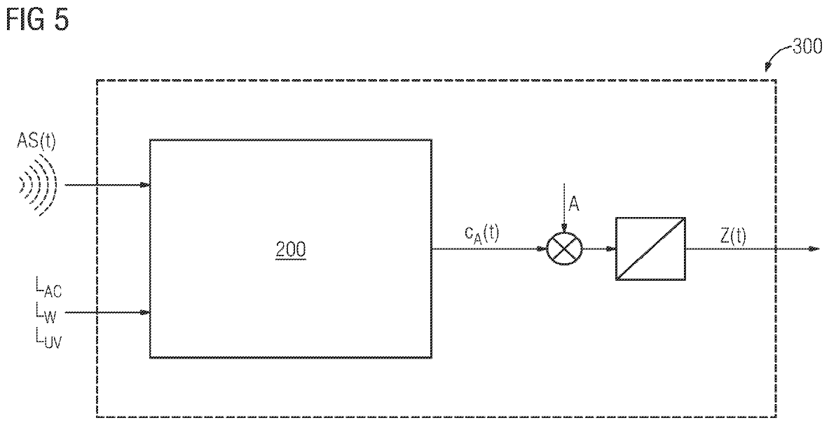

FIG. 5 shows a schematic representation of a device 300 for determining an inhalation dose Z. More precisely, the risk of infection can be quantified by ascertaining not only the concentration c_{A} in the volume, but also determining a time-dependent inhalation dose Z at a time t for a notional person or for one (or each) of the persons present. For this purpose, a time course of the concentration c_{A} of potentially infectious aerosol particles is determined. The inhaled dose Z over the time of presence in the volume V (e.g. in the room 100) is given by the integral of a respiratory air demand A and the concentration c_{A} over time. This procedure can also be realized in real time. If the inhalation dose Z exceeds a critical value at any time, ventilation can be recommended or an emergency warning to evacuate the room may be issued. This significantly minimizes the likelihood of infection. This procedure can also take into account safety factors. The respiratory air demand A can be selected as a constant or time-dependent value, e.g. for a singer.

### LIST OF REFERENCE SIGNS

100 room
110, 112 window
AC air conditioning system
UV air purification device
V volume of the room
E1, . . . , En emitters in the room
200 device for ascertaining a concentration of potentially infectious aerosol particles
210 detection device e.g. microphone
220 evaluation device for acoustic variables
230 classification device (detection and classification of acoustic events)
240 device for ascertaining an aerosol particle decrease in the volume
250 device for ascertaining the emission
260 device for ascertaining the potentially infectious concentration
t time
Q emission of aerosol particles
q emission rate of aerosol particles
c_{A} concentration of aerosol particles
A respiratory air requirement of a person
Z inhalation dose
AS acoustic variable
AE acoustic event
λ decrease rate of aerosol particles
L_{AC} air exchange rate through an air conditioner
L_{W} air exchange rate through open windows
L_{UV} air exchange rate through air purifier

What is claimed is:

1. A method for ascertaining a concentration of potentially infectious aerosol particles in a volume housing emitters of the aerosol, the method comprising:
recording a time course of an acoustic variable in the volume, the acoustic variable associated with one or more of the emitters;
ascertaining an emission of aerosol particles for at least one of the emitters on the basis of the recorded time course of the acoustic variable; and
ascertaining the concentration on the basis of the emission.

2. The method as claimed in claim 1, wherein the acoustic variable comprises a sound pressure level and/or an audio signal in the volume.

3. The method as claimed in claim 1, wherein at least a part of the time course is assigned to one of the emitters or a group of emitters.

4. The method as claimed in claim 1, wherein ascertaining the emission includes integrating an emission rate as a function of the time course of the acoustic variable.

5. The method as claimed in claim 1, further comprising ascertaining a separate emission for each of a plurality of emitters;
wherein the concentration is ascertained on the basis of the largest of the determined emissions.

6. The method as claimed in claim 1, wherein ascertaining the concentration include using a proportion factor for weighting the emissions.

7. The method as claimed in claim 1, further comprising including a decrease rate of potentially infectious aerosol particles to ascertain the concentration and/or the emission.

8. The method as claimed in claim 1, further comprising detecting a gas occurring in the respiratory air to ascertain a decrease rate of potentially infectious aerosol particles in the respiratory air.

9. The method as claimed in claim 1, further comprising weighting the emission on the basis of a detection of acoustic events in the time course of the acoustic variable.

10. The method as claimed in claim 1, further comprising taking into account segments of time courses of acoustic variables and/or segments of emissions resulting therefrom, which cannot be assigned to any emitter in ascertaining the concentration and/or the emission.

11. A method for ascertaining an inhalation dose, the method comprising:
ascertaining a concentration or potentially infectious aerosol particles in a volume housing emitters of the aerosol by:
recording a time course of an acoustic variable in the volume, the acoustic variable associated with one or more of the emitters;
ascertaining an emission of aerosol particles for at least one of the emitters on the basis of the recorded time course of the acoustic variable;
ascertaining the concentration on the basis of the emission; and
ascertaining an expected inhalation dose for at least one person in the volume at a time.

12. The method as claimed in claim 11, wherein ascertaining the inhalation dose includes performing an integral of the concentration and a respiratory air demand at the time.

13. A device for ascertaining a concentration of potentially infectious aerosol particles in a volume, the device comprising:
a detection device for recording time courses of one or more acoustic variables in a volume; and
an evaluation device for ascertaining an emission of aerosol particles for at least one emitter on the basis of the recorded time course of the acoustic variable;
wherein the evaluation device ascertains the concentration on the basis of the at least one emission.

14. The device as claimed in claim 13, further comprising an interface which for connecting detection devices external to the device.

15-16. (canceled)
